(19) United States
(12) Patent Application Publication
(10) Pub. No.: US 2006/0131873 A1
(43) Pub. Date: Jun. 22, 2006

(54) High pressure swivel joint

(76) Inventors: Kenneth E. Klingbail, Wonder Lake, IL (US); Andrew J. Johnson, Island Lake, IL (US)

Correspondence Address: Patel & Alumit, P.C., Suite 302, 20121 Ventura Blvd., Woodland Hills, CA, 91364, US

(21) Appl. No.: 10/998,218

(22) Filed: Nov. 26, 2004

(51) Int. Cl. F16L 37/52

(52) U.S. Cl. 285/147.1

(57) ABSTRACT

An improved high-pressure swivel joint, which can be used to connect two conduits rotatably. The swivel joint includes an inner conduit and an outer conduit, which are secured together by means of linear roller bearings. Elastomeric packing is provided to prevent the fluid from entering the bearings. The unique design of the swivel joint allows it to be safely used in high pressure and high velocity fluid transfers and also for sour gas services.

### CROSS-REFERENCE TO RELATED APPPLICATION

None

### FEDERALLY SPONSORED RESEARCH

Not Applicable

### SEQUENCE LISTING OR PROGRAM

Not Applicable

### BACKGROUND OF THE INVENTION

1. Field of Invention

The present invention relates to a device that allows sections of rigid pipe to be rotatably joined together in such a manner that a swivel connection is formed, and more particularly, to an improved swivel joint, which is suitable for high-pressure service and which has longer service life than conventional devices.

2. Prior Art

Pipe is used in many types of industries, including oil, ship and rail loading industries. During the servicing of new or existing oil wells, service companies use various mobile pumping systems to treat service conditions. These pumping services can deliver a variety of media, each for a specific purpose, such as cementing, acidizing, fracturing, stimulating testing and flowing back a well.

Delivering these fluids from the mobile systems to or from the well is done at extreme high pressures and flow rates. These conditions preclude the use of flexible hoses or even reinforced hoses. Thus, the oil field companies use steel hose with articulating connectors called swivel joints, which allow the steel hose to be positioned in as many ways as possible to make a rigid final connection prior to pressurization.

The steel materials of these products are thorough hardened to provide extreme high strength, toughness and abrasion resistance. Further, the swivel action is accomplished with ball bearings in matching raceways of mated swivel components and these raceways are case hardened to retain the bearing without distorting the races under high pressure induced loads.

Due to certain subterranean conditions, pressurized service fluids can become contaminated with Hydrogen Sulfide, a naturally occurring, powerfully corrosive, toxic gaseous constituent of geological formations. The National Association of Corrosion Engineers (N.A.C.E.) standard MR0175 details the conditions of materials for use in H₂S containing environments. Specifically, steel and alloy steel materials above a certain hardness threshold become susceptible to Sulfide Stress Corrosive Cracking (SSC) and sudden failure under pressure. Therefore, these metals must be thermally treated to have a final hardness below the threshold level.

Swivel joints and steel hose products exposed to H₂S cannot be case hardened and thorough hardened as are standard service products. However, these products must handle internal pressures up to but not limited to 15,000 psi and test pressures up to 22,500 psi.

Other swivel joint designs for sour gas service utilize ball bearings as in the standard service design, but also employ U-shaped stainless steel raceway liners “snapped” into an enlarged raceway in each mating component. During assembly, the ball bearings are inserted through ball ports and between the “snap-in” liners for each race. These stainless steel liners are not securable except by a springing action in the enlarged raceways, and are free to slide during rotation, almost always ending up covering the port opening used to insert the balls. Once covered, it is extremely difficult to slide the liners back into the original position, where the balls can be removed to disassemble the swivel joint for service inspection and removal.

Most of the current high-pressure long radius swivel joints have the same type of swivel connection. A row of chrome steel balls is set in as few as one or as many as four raceways. In current ball bearing swivel joints intended for sour gas service, the “snap-in” raceway liners are rolled from 304 stainless steel and sprung into the machined raceways of the inner and outer swivel components. There is a slight offset of the inner components and the outer components raceways. During assembly, force is applied to squeeze the two components against the packing, until the raceways are aligned, and the balls are installed. This is in effect a “preload” compression of the elastomeric packing. Each ball has a single point contact with the raceway insert. Under extreme load or high pressure, the balls will indent the surface of the insert. This deformation is known as “brinelling”. After just a few extreme pressure cycles, the amount of brinelling or surface deformation significantly increases. Eventually the deformation will permanently decrease the cross sectional thickness of the raceway liners. As the liner thickness decreases, the amount of assembly compression on the packing is reduced. Once the deformation is sufficient, the swivel components can push apart under pressure and the joint will leak past the packing. The entire swivel then must be removed from service, and renewed or replaced.

For the foregoing reasons, there is a need for a swivel joint rotating mechanism that does not require the mating components to be case or thorough hardened beyond N.A.C.E. stipulated limits, and thus is suitable for use in high pressure equipment exposed to sour gas.

### BACKGROUND OF THE INVENTION—OBJECTS AND ADVANTAGES

It is an object of the invention to provide an improved swivel joint, which is capable of moving fluids under high pressure and also in the presence of sour gas.

It is another object of the invention to provide an improved swivel joint in which linear roller bearings are used, which provide for larger contact area against the walls of the raceways.

Another object of the invention is to provide an improved swivel joint, which does not require any raceway liners, which may slide after several pressure cycles.

A further object of the invention is to provide an improved swivel joint, which has an extended life span when compared to existing devices.

Still another object of the invention is to provide an improved swivel joint in which there is no need of case hardening the raceways as precluded for equipment used in sour gas service.

Another object of the invention is to provide an improved swivel joint with an improved four-piece seal to avoid the high pressure, high velocity fluids passing through the joint.

Yet another object of the invention is to provide an improved swivel joint where the four-piece seal requires less torque to rotate which makes assembly easier.

It is another object of the invention to provide an improved swivel joint wherein the lip on which the four-piece seal rests, is used as a wear indicator.

Still another object of the invention is to provide an improved swivel joint wherein a dust seal is used for promoting joint integrity in submerged service.

Further objects and advantages will become apparent from a consideration of the ensuing description and drawings.

### SUMMARY

In accordance with the present invention, a high-pressure swivel joint comprises a linear roller bearing assembly to provide for the swiveling action, a four-piece pressure assisted seal to avoid the fluid passing through the joint, and a wear indicator.

The linear roller bearings have a larger contact area with raceways thereby eliminating the need for raceway liners. The four-piece seal requires less torque to rotate, which makes assembly easier.

### DRAWINGS—FIGURES

FIG. 1 is a side view of the swivel joint.

FIG. 2 is an exploded view of the radial seal.

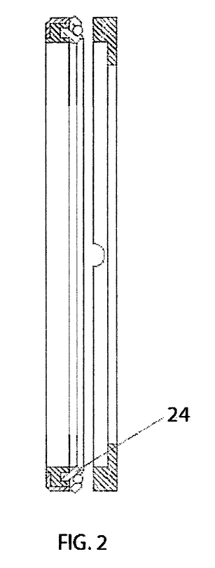

FIG. 3 is a side view of the first pipe section.

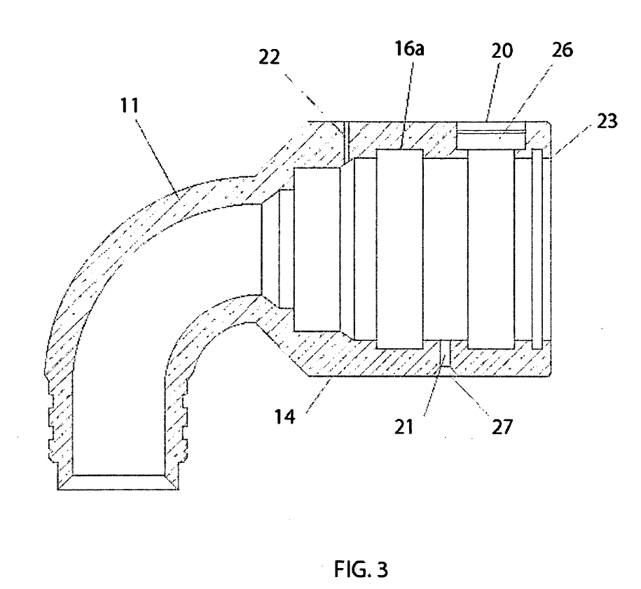

FIG. 4 is a front view of the second pipe section.

FIG. 5 is a side view of the third pipe section.

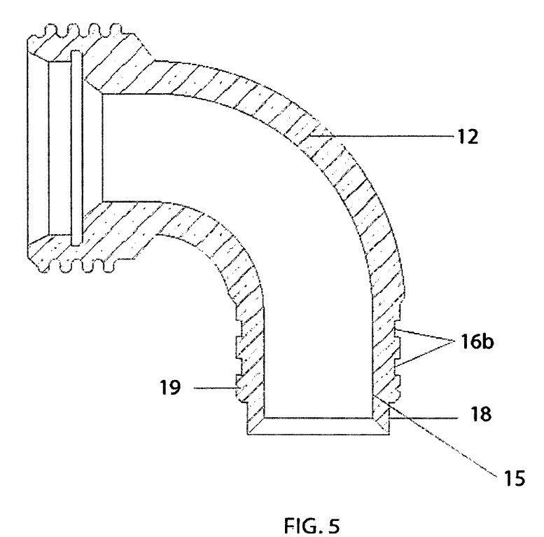

FIG. 6 is a side view of the first pipe section showing the two access ports.

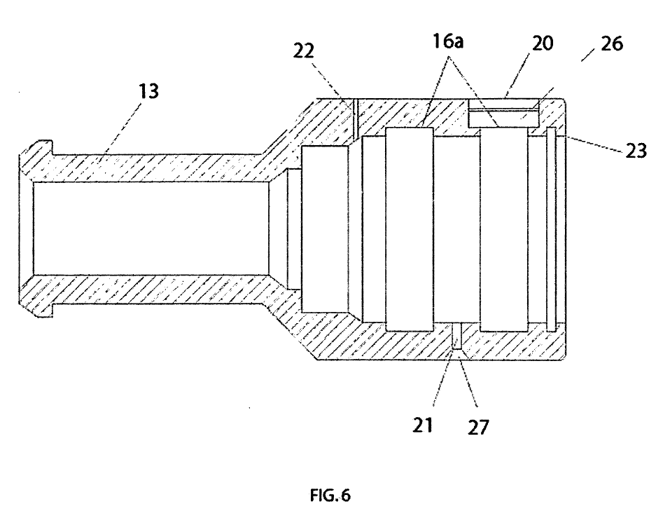

### DRAWINGS—REFERENCE NUMERALS

11 First Pipe Section
12 Second Pipe Section
13 Third Pipe Section
14 Sleeve of the First End of the First Pipe Section
15 First End of the Second Pipe Section
16a Internal Raceways
16b External Raceways
17 Linear Roller Bearings
18 Lip for the Elastomer Seal on the Second Pipe Section
19 Groove for the O-ring
20 Access Ports
21 Port for Lubricants
22 Leakage Detection Port
23 Recessed Area for the Dust Seal
24 Elastomer Seal
25 O-ring
26 Retaining Plugs
27 Lub Plug
28 Dust Seal

### DETAILED DESCRIPTION—PREFERRED EMBODIMENT

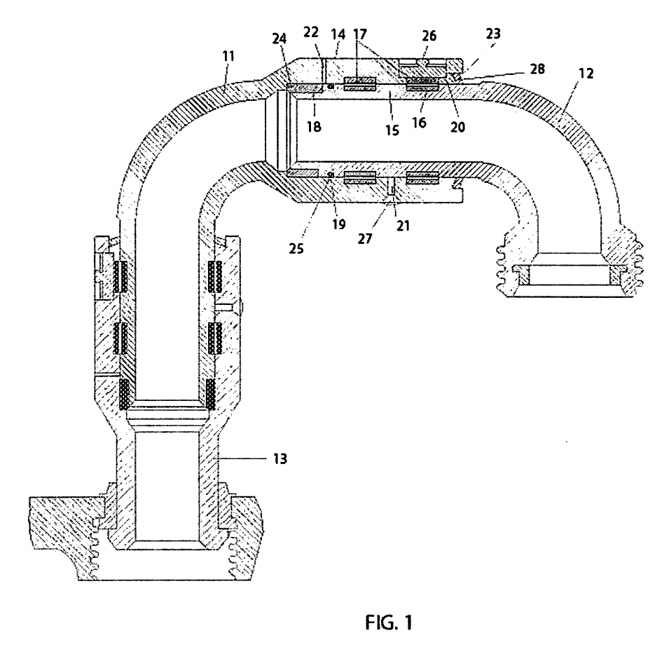

Referring to the drawings, FIG. 1 shows an overall view of the high-pressure swivel joint.

There are two pipe sections 11 and 12. The first pipe section 11 and second pipe section 12 are connected by linear roller bearing assemblies. The first end of the first pipe section 11 has a sleeve 14.

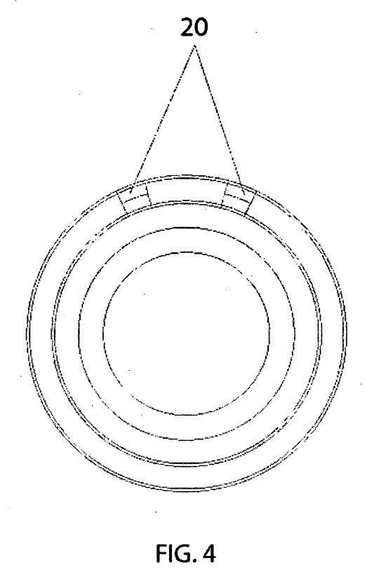

The sleeve 14 contains a plurality of internal circumferential raceways 16a. The sleeve 14 has a recessed area 23 at the end to provide room for a dust seal 28. The sleeve 14 also has a plurality of ports 20, 21, 22. There are two access ports 20, which are visible in FIG. 4. These two ports 20 are offset by an angle of approximately 30 degrees.

In FIG. 1, the first end 15 of the second pipe section 12 has an external diameter equal to that of the internal diameter of the sleeve 14 of the first pipe section 11. The first end 15 also has a plurality of external circumferential raceways 16b to match with the internal raceways 16a of the sleeve 14.

The first end 15 of the second pipe section 12 also has a lip 18 and a groove 19. A four piece elastomer seal 24 is introduced onto the lip 18. An O-ring 25 is snapped into the groove 19.

The linear roller bearings 17 are introduced into the raceways 16 through the access ports 20. Retaining plugs 26 are used to retain the bearings 17 in the raceways 16.

The second ends of the pipe sections can be connected to other pipes by other means of connections or by swivel joints as required.

Operation

The operation of the high-pressure swivel joint is identical to existing swivel joints. The swivel joint generally serves to connect two pipes in a rotatable manner. The swivel is made from alloy steel, machined to specific dimensions. It is then thermally treated to specific material hardness with mechanical properties suitable for the intended service.

The pipe sections 11 and 12 are mated. The two pipe sections 11 and 12 are mated such that the first end 15 of the second pipe section 12 enters the sleeve 14 of the first pipe section 11. The mated swiveling components have specifically dimensioned faces which seal against the four-piece seal 24. This packing is the products primary seal to contain internal fluids and protect the bearings 17 from fluid exposure.

Prior to mating, the four piece elastomer seal 24 and O-ring 25 are introduced respectively on to the lip 18 and the groove 19. The four-piece elastomer seal 24 is pressure assisted, so sealing is effective at any pressure up to the working limits of the joint. Moreover, this seal requires less torque to rotate than conventional seals, which makes assembly easier.

The lip 18 is useful as a wear indicator. When the lip 18 erodes and corrodes from exposure to the high-pressure and high velocity fluids, the elastomer seal 24 will leak and indicate that the lip 18 is worn through. When the seal 24 leaks, fluids come out through the leak-detection port 22.

Lubricants are introduced into the bearing through port 21. A plug 27 is used to contain the lubricants inside the bearing.

The sleeve 14 of the first pipe section 11 has a recessed area 23 at the end to provide room for a dust seal 28. The dust seal 28 helps retain the joint integrity in submerged service.

The linear roller bearings 17 are introduced into the raceways 16 through the access ports 20 which are offset by an angle of approximately 30 degrees. Multiple rows of linear roller bearings 17 support equal areas of the internal and external portions of the raceways 16. Retaining plugs 26 are used to retain the linear roller bearings 17 in the raceways 16. These retaining plugs 26 keep the bearings from falling out and prevent internal environmental contamination.

The linear roller bearings 17 have larger contact areas with the raceways 16 when compared to that of ball bearings. This allows the axial load to be distributed over a larger bearing area resulting in significantly lower strain at the raceways 16, thereby eliminating the need for a raceway liner. The increased contact bearing area eliminates the need to case harden the raceways 16, as precluded for sour gas service.

Although specific embodiments of this invention have been shown and described, it will be apparent to those skilled in the art that many modifications of those embodiments may be made without departing from the inventive concepts claimed herein. Accordingly, the invention is not limited to the specific embodiments set forth above, but is of fill breadth and scope of the appended claims.

What is claimed is:

1. An improved high pressure swivel joint comprising: a first pipe section, the first end thereof having a sleeve; a second pipe section, the first end thereof having an external diameter equal to the internal diameter of the sleeve of said first pipe section; means for mating said pipe sections in a rotatable relation; and means for sealing the space between said pipe sections to protect against leakage.

2. An improved high pressure swivel joint according to claim 1 wherein said sleeve has a plurality of internal raceways and a plurality of ports.

3. An improved high pressure swivel joint according to claim 1 wherein the first end of the second pipe section has a plurality of external raceways to match with that of said internal raceways of the sleeve of the first pipe section.

4. An improved high pressure swivel joint according to claim 1 wherein said means for mating said pipe sections comprises a plurality of roller races and roller bearing assemblies interposed between said pipe sections.

5. An improved high pressure swivel joint according to claim 1 wherein said second pipe section includes a lip to provide a sealing surface.

6. An improved high pressure swivel joint according to claim 5 wherein said means for sealing comprises: an atmospheric end seal situated in a recessed area on said sleeve of the first pipe section such that said end seal mates with the first end of the second pipe section; and an internal end seal situated on the sealing surface provided by said lip.

7. An improved high pressure swivel joint according to claim 1 wherein said sleeve of the first pipe section has ports for introducing said linear roller bearings into said raceways, for detecting leakage, and for introducing lubricants.

8. An improved high pressure swivel joint according to claim 7 wherein said ports for introducing the linear roller bearings and the lubricants have retaining plugs.
